(19) United States
(12) Patent Application Publication
(10) Pub. No.: US 2010/0130085 A1
(43) Pub. Date: May 27, 2010

(54) MOISTURE-VAPOR-BREATHABLE AND LIQUID-IMPERMISSIBLE STRUCTURES, MOISTURE-VAPOR-BREATHABLE AND LIQUID-IMPERMISSIBLE UPHOLSTERY STRUCTURES AND METHODS OF MAKING MOISTURE-VAPOR-BREATHABLE AND LIQUID-IMPERMISSIBLE STRUCTURES

(75) Inventor: Wei-Ching Yu, Marietta, GA (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: Invista North America S.a r.l., Wilmington, DE (US)

(21) Appl. No.: 12/277,553

(22) Filed: Nov. 25, 2008

(51) Int. Cl. B32B 27/12; B32B 5/24

(52) U.S. Cl. 442/370; 442/394

(57) ABSTRACT

Briefly described, embodiments of this disclosure, among others, include moisture-vapor-breathable and liquid-impermissible structures (e.g., pads, cushions, padding, and the like, for the seat, arms, back, etc. of upholstery furniture), and/or upholstery structures (e.g., upholstery furniture) that include moisture-vapor-breathable and liquid-impermissible structure, methods of making moisture-vapor-breathable and liquid-impermissible structures.

### CROSS-REFERENCE TO RELATED APPLICATION

This application claims priority to U.S. provisional application entitled, “MOISTURE-VAPOR-BREATHABLE AND LIQUID-IMPERMISSIBLE UPHOLSTERY STRUCTURES AND METHODS OF MAKING MOISTURE-VAPOR-BREATHABLE AND LIQUID-IMPERMISSIBLE UPHOLSTERY STRUCTURES,” having Ser. No. 60/911,355, filed on Nov. 30, 2007, which is entirely incorporated herein by reference.

### FIELD OF THE DISCLOSURE

This invention(s) relates to upholstery structure having moisture-vapor permeable and liquid impermeable properties. In particular, the upholstery structure can be used for making upholstery furniture.

### BACKGROUND

In a conventional process of manufacturing liquid-barrier upholstery seating furniture, an upholstery fabric is back-coated with a polymeric coating to prevent a liquid penetrating the upholstery fabric. More recently, processes have been developed for a breathable polymeric film that is back-laminated on the underside of an upholstery fabric to form a laminate. The pre-coated fabric or the film-upholstery-fabric laminate can then be wrapped on a pad of upholstered furniture.

A large number of upholstery fabrics are normally used with different fibers and in different styles. Lamination or coating short rolls of these fabrics requires extensive handling and roll management. The manufacturing process has to be stopped in order to change the rolls. This increases the manufacturing cost for bonding liquid-barrier films or coatings onto upholstery fabrics, especially when a manufacturer offers a variety of styles. Furthermore, the liquid-impermeable upholstery fabric can be stiff due to the lamination or coating on the fabric even though the appearance is acceptable.

### SUMMARY

Briefly described, embodiments of this disclosure, among others, include moisture-vapor-breathable and liquid-impermissible structures (e.g., pads, cushions, padding, and the like, for the seat, arms, back, etc), upholstery structures (e.g., upholstery furniture) that include moisture-vapor-breathable and liquid-impermissible structures, and methods of making moisture-vapor-breathable and liquid-impermissible structures.

One exemplary moisture-vapor-breathable and liquid-impermissible structure, among others, includes: a substrate having an upper surface and a lower surface; a moisture-vapor-breathable and liquid-impermissible laminate disposed over at least the upper surface of the substrate; and an upholstery fabric sheet having a face side and underside, wherein the underside of the upholstery fabric sheet is disposed over the moisture-vapor-breathable and liquid-impermissible laminate.

One exemplary upholstery structure, among others, includes: a structure having a moisture-vapor-breathable and liquid-impermissible property, wherein the structure includes: a substrate having an upper surface and a lower surface; a moisture-vapor-breathable and liquid-impermissible laminate disposed over at least the upper surface of the substrate; and an upholstery fabric sheet having a face side and underside, wherein the underside of the upholstery fabric sheet is disposed over the moisture-vapor-breathable and liquid-impermissible laminate.

One exemplary method for the preparation of a moisture-vapor-breathable and liquid-impermissible structure, among others, includes: providing a substrate having an upper and lower surface; disposing a moisture-vapor-breathable and liquid-impermissible laminate on at least the upper surface of the substrate; and disposing an upholstery fabric sheet on the moisture-vapor-breathable and liquid-impermissible laminate.

### DETAILED DESCRIPTION

Before the present disclosure is described in greater detail, it is to be understood that this disclosure is not limited to particular embodiments described, as such may, of course, vary. It is also to be understood that the terminology used herein is for the purpose of describing particular embodiments only, and is not intended to be limiting, since the scope of the present disclosure will be limited only by the appended claims.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features that may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of chemistry, the fabric industry, textiles, and the like, which are within the skill of the art. Such techniques are explained fully in the literature.

The following examples are put forth so as to provide those of ordinary skill in the art with a complete disclosure and description of how to perform the methods and use the compositions and compounds disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is in atmospheres. Standard temperature and pressure are defined as 25° C. and 1 atmosphere.

Before the embodiments of the present disclosure are described in detail, it is to be understood that, unless otherwise indicated, the present disclosure is not limited to particular materials, reagents, reaction materials, manufacturing processes, or the like, as such can vary. It is also to be understood that the terminology used herein is for purposes of describing particular embodiments only, and is not intended to be limiting. It is also possible in the present disclosure that steps can be executed in different sequence where this is logically possible.

It must be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

### Definitions

The term “permeable” denotes a moisture vapor transport rate of about 100 g/m²/day or more, determined by ASTM E96 upright cup method.

The terms “breathable”, “vapor breathability”, and “air permeability” may be used interchangeably with “permeable” herein.

The term “liquid-impermeable,” “liquid-impermissible,” or “liquid-repellent” as used herein means impervious or substantially impervious to liquid, especially to an aqueous solution. For the purpose of description in the present disclosure, the term of “water” is used herein for representing aqueous solution. The term “liquid-impermeable laminate” or “liquid-impermissible laminate” refers to a laminate that is impervious or substantially impervious to water penetration through the laminate. The term “liquid-impermeable coating” or “liquid-impermissible coating” refers to a coating on a material (e.g., a fabric substrate) that is impervious or substantially impervious to water penetration through the laminate. The liquid-impermeable coating can form a layer on the surface of the material and/or penetrate into the material.

The term “substantially impervious to water penetration” used herein refers to the extent of water penetration through the laminate for a given end-use application that is acceptably low for that particular application. For example, it may be desirable to provide overstuffed furniture cushions that do not absorb spilled water. For that end-use application, if the rate of water evaporation from the fabric into the air is about the same as or exceeds the rate of water diffusion through the membrane, then the laminated fabric would meet the objective of avoiding absorption of spilled water and would meet the definition of “substantially impervious to water penetration.”

The term “moisture-vapor-breathable and liquid-impermissible property” used herein refers to a characteristic of an item (e.g., a cushion) that is moisture-vapor-breathable and liquid-impermissible as those terms are defined herein.

The term “moisture-vapor-breathable and liquid-impermissible laminate or coating” as used herein includes a film or coating disposed on a substrate. The moisture-vapor-breathable and liquid-impermissible laminate can be disposed directly on the substrate or indirectly (e.g., via an adhesive layer) on the substrate

The term “substrate” as used herein can include, but is not limited to, the substrate is selected from a foam, a fabric, a batting, or combinations thereof. In particular, the substrate can include, but is not limited to, a polyurethane foam, a nonwoven fabric, a woven fabric, a batting, and combinations thereof.

The term “pad” as used herein can be a compressible resilient material (e.g., cushion or padding). The thickness of the pad may be selected to be consistent with considerations of cost, comfort, and aesthetics for a given application. For example, the pad may have thickness in the range from about 0.125 inches (0.32 centimeters) to 10 inches (25 centimeters). A compressible and recoverable natural or synthetic material, or a combination of both, can be used for the pad. Naturally occurring materials suitable for use as the pad include jute and cotton. Suitable synthetic materials for the pad include fiber batting, polyurethane foams, and the agglomeration of polyurethane foam pieces known as “re-bond”.

The term “upholstery fabric sheet” as used herein can include sheets formed of one or more types of fibers and/or yarns. The fiber materials include, but are not limited to, synthetic materials such as aramids (for example, Nomex® brand aramid fibers manufactured by DuPont), viscose (for example, Visil® brand viscose fibers manufactured by Sateri Oy of Finland) and inherently flame-resistant polyester (such as Avora® brand polyester manufactured by INVISTA S. á r. I. of Wichita, Kans. and Wilmington, Del.), and the like, and the blends thereof, as well as other fibers known in the art.

The term “treated upholstery fabric sheet” as used herein refers to an upholstery fabric sheet that has been treated with one or more chemical treatments (e.g., treated with a primary treatment composition).

The terms “structure” or “upholstery structure” as used herein can include a piece of upholstery furniture (e.g., for the home and/or office) such as, but not limited to, a bed, a bed padding, a sofa, an ottoman, a chair, and the like. The structure also includes portions of furniture in other independent structures such as a pad such as a cushion, a padding, and the like.

### Discussion

Embodiments of the present disclosure include moisture-vapor-breathable and liquid-impermissible structures (e.g., pads, cushions, padding, and the like, for the seat, arms, back, and the like) and upholstery structures (e.g., upholstery furniture) that include a moisture-vapor-breathable and liquid-impermissible structure. In addition, embodiments of the present disclosure include methods of making moisture-vapor-breathable and liquid-impermissible structures (e.g., pads, cushions, padding, and the like). Furthermore, embodiments of the present disclosure include moisture-vapor-breathable and liquid-impermissible structures, pads, cushions, padding, and the like that include upholstery fabric sheets that have been treated with stain resistant agents and/or anti-microbial agents, as well as with other desirable agents.

Embodiments of the present disclosure are advantageous because the selections of upholstery fabrics that can be used with embodiments of the present disclosure are not limited to upholstery fabrics laminated with a barrier film or coated with barrier resin. As a result, many styles of upholstery fabrics treated or untreated with stain and soil resistant chemicals can be used to make liquid-impermeable and vapor-breathable upholstery cushion furniture. Embodiments of the present disclosure may reduce manufacturing costs because the upholstery fabrics are not in the lamination process. Embodiments of the present disclosure may enhance manufacturing flexibility by facilitating mass production of a variety of upholstery furniture designs since only a few grades of film laminates are needed. Embodiments of the present disclosure may also provide upholstery fabric with improved hand as well as improved seating comfort.

As mentioned above, embodiments of the present disclosure relate to upholstery structures (e.g., upholstery furniture such as, but not limited to, sofas, chairs, ottomans, beds, and furniture (e.g., office and home) that include cushions or padding) including pads, cushions, or padding, with moisture-vapor-permeable and liquid-impermeable properties and/or stain resistant and/or anti-microbial properties.

In particular, an embodiment of the present disclosure includes a moisture-vapor-breathable and liquid-impermissible structure, such as a cushion, having a moisture-vapor-breathable and liquid-impermissible property. The cushion includes, but is not limited to, a substrate, such as a pad, having an upper surface and a lower surface; a moisture-vapor-breathable and liquid-impermissible laminate disposed (e.g., wrapped or overlaid) over at least the upper surface of the pad; and an upholstery fabric sheet disposed (e.g. wrapped or overlaid) over the moisture-vapor-breathable and liquid-impermissible laminate. The moisture-vapor-breathable and liquid-impermissible laminate can be disposed on the top (area towards where one would sit) of the pad, on the top and sides of the pad, or on the substantially the entire surface of the pad (e.g., top, sides, and bottom). The term “wrapping” can include edge-sealing, sewing, and a combination thereof.

In an embodiment, the moisture-vapor-breathable and liquid-impermissible laminate can include a polymeric barrier film having a face side and an underside, and a substrate overlaying the underside of the polymeric barrier film. Additional details are provided below. The face side of the polymeric barrier film is disposed adjacent the underside of the upholstery fabric sheet.

In another embodiment, the moisture-vapor-breathable and liquid-impermissible laminate can include a polymeric barrier film having a face side and an underside, a polymeric adhesive layer covering the underside of the film, and a substrate overlaying the adhesive layer. Additional details are provided below. The face side of the polymeric barrier film is disposed adjacent the underside of the upholstery fabric sheet.

In an embodiment, the polymeric barrier film includes a moisture-vapor-breathable and liquid-barrier film. The moisture-vapor-breathable and liquid-barrier film is a film such as, but not limited to, a monolithic film, a microporous polypropylene film, a copolyester film, a microporous polytetrafluroethylene film, and combinations thereof. The monolith film can be a film such as, but not limited to, a polyester-based thermoplastic elastomer film, a polyurethane-based thermoplastic elastomer film, a polyamide-based thermoplastic elastomer film, or combinations thereof. Additional details are provided below.

In an embodiment, the upholstery fabric sheet is a treated fabric sheet. The treated fabric sheet can be treated with a primary treatment composition, as described in more detail below.

Another embodiment of the present disclosure includes a cushion having a moisture-vapor-breathable and liquid-impermissible property. The cushion includes, but is not limited to, a pad having an upper surface and a lower surface; a moisture-vapor-breathable and liquid-impermissible coating on a fabric substrate, where the fabric substrate is disposed (e.g., wrapped or overlaid) over at least the upper surface of the pad; and a fabric sheet is disposed (e.g. wrapped or overlaid) over the moisture-vapor-breathable and liquid-impermissible laminate. The fabric substrate can be disposed on the top (area towards where one would sit) of the pad, on the top and sides of the pad, or on substantially the entire surface of the pad (e.g., top, sides, and bottom). In an embodiment, the upholstery fabric sheet is a treated fabric sheet. The treated fabric sheet can be treated with a primary treatment composition, as described in more detail below.

An upholstery fabric (also referred to as “fabric sheet” and “upholstery fabric sheet”) suitable for use in the present disclosure has a face side and an underside. The upholstery fabric can be formed in weaving and knitting. The upholstery fabric can be plain or can be made in patterns.

The upholstery fabric sheet can be treated with a primary treatment composition. The primary treatment composition includes at least one or any combination of a fluorochemical compound, a cross-linking agent, and a stain resistant agent. One or more antimicrobial agents can also be added to the primary treatment composition to treat the fabric sheet.

The primary treatment composition can be prepared by mixing any combination of fluorochemical compounds, cross-linking agents, stain resistant agents, antimicrobial agents, and other ingredients with water until a uniform dispersion is obtained. The upholstery fabric can then be topically treated with the primary treatment composition. The primary treatment composition can cover at least the face side or both sides of the upholstery fabric. In an embodiment, the upholstery fabric sheet is then oven dried and cured at elevated temperatures in the range of from about 120° C. to 180° C.

The fluorochemical compounds that can be used in the present disclosure can be water insoluble and can have one or more fluoro-aliphatic radicals, for example, one or more perfluoroalkyl radicals.

In one embodiment of the present disclosure, the fluorochemical can be fluorocarbonylimino biuret as disclosed in U.S. Pat. No. 4,958,039 (Pechhold), which is incorporated herein by reference. The fluorochemical can be the reaction product of two moles of a mixture of fluoroalcohols of the formula F(CF₂CF₂)ₙCH₂CH₂OH, where n can be 3, 4, or 5, with one mole of 1,3,5-tris(6-iso-cyanotohexyl)biuret followed by reaction of residual isocyanate groups with a modifier such as 3-chloro-1,2-propanediol.

In another embodiment of the present disclosure, the fluorochemical can be a fluoroester such as disclosed in U.S. Pat. No. 3,923,715 (Dettre) and U.S. Pat. No. 4,029,585 (Dettre), which are incorporated herein by reference. These patents disclose perfluoroalkyl esters of carboxylic acids of 3 to 30 carbon atoms. An example is a citric acid ester of perfluoroalkyl aliphatic alcohols such as a mixture of 2-perfluoroalkyl ethanols containing 8 to 16 carbon atoms.

In yet another embodiment, the fluorochemical can be a fluoroester urethane compound such as those described in the aforementioned U.S. Pat. No. 4,029,585. An example is the citric acid urethane obtained by reacting the citric acid ester mentioned above with 1-methyl-2,4-diisocyanatobenzene.

In yet another embodiment of the present disclosure, the fluorochemical can be a fluoropolymer as disclosed in U.S. Pat. No. 3,645,990 (Raynolds), which is incorporated herein by reference. Useful fluoropolymers can include fluorinated polymers from acrylic and methylacrylic derived monomers having the structures

CH₂═CH—CO₂CH₂CH₂R_{f}

and

CH₂═C(CH₃)—CO₂CH₂CH₂R_{f}

where R_{f} is a perfluoroalkyl group of about 4 to 14 carbons, and methyl acrylate or ethyl acrylate, optionally with small amounts of other monomers. An example of such a fluoropolymer is the copolymer of the last mentioned formula, wherein R_{f} is a mixture of perfluoroaliphatic radicals of 8 to 16 carbons, with methylacrylate in a 74:26 weight ratio.

Commercially available fluorochemical compounds can be used in embodiments of the present disclosure. These compounds include, but are not limited to, fluorochemical products Zonyl® 8070, Zonyl® 7713, and Zonyl® 7910, available from E. I. DuPont de Nemours, Wilmington, Del.; and Scotchguard™ FC255 and Scotchguard™ FC214-230, available from 3M, St. Paul, Minn.

Cross-linking agents suitable for use in the primary treatment composition include resins that can form covalent bonds between polymeric molecules of the fabrics. The cross-linking agents include compounds that may be functionalized by hydroxyl groups, carboxyl groups, carbonyl groups, or amine groups. As known to those skilled in the textile industry, the efficiency of the cross-linking process can often be enhanced by using a catalyst. For example, ionic salts may be added to the cross-linking agent to promote cross-linking when the applied composition's temperature is raised above a certain critical threshold.

In one embodiment, the cross-linking agent can be a non-formaldehyde resin. The non-formaldehyde resins include, but are not limited to, an emulsified or water-soluble multifunctional polycarbodiimide, polycarboxylic acid, dimethyl dihydroxyethlene urea, glyoxal, diisocyanate, diepoxide, and dihaloalkane. Typical polycarboxylic acids include, but are not limited to, butanetetracarboxylic acid, polymaleic acid, and citric acid. An example of a glyoxal is dimethylureaglyoxal. One example of commercially available polycarbodiimide is Carbodilite E-02 manufactured by Advanced Polymer, Inc. of Carlstadt, N.J.

The stain resistant agents include at least one of the water-soluble or water-dispersible polymeric sulfonated phenol-formaldehyde condensation products, mixtures containing any of hydrolyzed maleic anhydride/α-olefin copolymers, hydrolyzed maleic anhydride/styrene copolymers, polymethacrylic acid polymers, polymethacrylic acid copolymers, or mixtures of the above compositions.

The polymeric sulfonated phenol-formaldehyde condensation products can include those useful as dye-resist agents or dye-fixing agents. Particular examples include, but are not limited to, diphenolic sulfones, and sulfonated naphthalene condensates. A particular sulfonated phenol-formaldehyde contains a condensation product of 4,4′-dihydroxy diphenolsulfone, and formaldehyde. Other sulfonated phenol-formaldehyde condensation products include those disclosed in U.S. Pat. Nos. 5,501,591; 5,592,940; 4,680,212; 4,822,373; 4,937,123; 5,447,755; 5,654,068; 5,708,087; 5,707,708; 5,074,883; 4,940,757; 5,061,763; and 5,629,376, which are all incorporated herein by references in their entireties.

A variety of linear and branched chain alpha-olefins (α-olefin) can be used to form a copolymer with maleic anhydride. Particularly useful alpha-olefins are 1-alkenes, containing 4 to 12 carbon atoms, preferably C₄₋₁₀, such as isobutylene, 1-butene, 1-hexene, 1-octene, 1-decene, and dodecene. Hydrolyzed maleic anhydride/styrene copolymers are also useful in embodiments of the present disclosure.

A part of the maleic anhydride in the copolymer can be replaced by acrylic acid, methacrylic acid, itaconic acid, vinyl sulfonic acid, vinyl phosphonic acid, styrene sulfonic acid, alkyl(C₁₋₄) acrylate, alkyl(C₁₋₄) methacrylate, vinyl acetate, vinyl chloride, vinylidine chloride, vinyl sulfides, N-vinyl pyrrrolidone, acrylonitrile, acrylamide, and mixtures thereof.

In another embodiment, a part of the maleic anhydride can be replaced by maleimide, N-alkyl (C₁₋₄) maleimides, N-phenylmaleimide, fumaric acid, crotonic acid, cinnamic acid, alkyl (C₁₋₁₈) esters of the foregoing acids, cycloalkyl (C₃₋₈) esters of the foregoing acids, sulfated castor oil, or the like.

Maleic anhydride copolymers can be prepared according to the methods well-known in the art. The maleic anhydride polymers thus obtained can be hydrolyzed to free acids or their salts by reaction with water or alkali, or they can also be reacted with C₁₋₄ alkyl alcohol to provide polymeric alpha-olefin/maleic acid monoesters. Generally, the hydrolyzed maleic anhydride polymer, or the monoester polymer, should be sufficiently water-soluble that a uniform application to a fibrous surface can be achieved at an appropriate acidity. However, applications using water dispersions of the polymer mixed with a suitable surfactant may be used to impart stain-resistance.

Preparation of maleic anhydride/alpha-olefin polymers is also described in Reissue U.S. Pat. No. 28,475 (Blecke) and in EP 306992 (Billman) the disclosures of which are specifically incorporated by reference. These references contain further teaching of techniques for the preparation of such polymers.

Methacrylic polymers include the polymethacrylic acid homopolymer as well as polymers formed from methacrylic acid and one or more other monomers. The monomers useful for copolymerization with the methacrylic acid are monomers having ethylenic unsaturation. Such monomers include, for example, monocarboxylic acids, polycarboxylic acids, and anhydrides; substituted and unsubstituted esters and amides of carboxylic acids and anhydrides; nitriles; vinyl monomers; vinylidene monomers; mono-olefinic and polyolefinic monomers; and heterocyclic monomers.

Representative monomers include, but are not limited to, acrylic acid, itaconic acid, citraconic acid, aconitic acid, maleic acid, maleic anhydride, fumaric acid, crotonic acid, cinnamic acid, oleic acid, palmitic acid, vinyl sulfonic acid, vinyl phosphonic acid, alkyl or cycloalkyl esters of the foregoing acids, alkyl or cycloalkyl having 1 to 18 carbon atoms such as, for example, ethyl, butyl, 2-ethylhexyl, octadecyl, 2-sulfoethyl, acetoxyethyl, cyanoethyl, hydroxyethyl and hydroxypropyl acrylates and methacrylates, and amides of the foregoing acids, such as, for example, acrylamide, methyacrylamide, and 1,1-dimethylsulfoethylacrylamide, acrylonitrile, methacrylonitrile, styrene, α-methylstyrene, p-hydroxystyrene, chlorostyrene, sulfostyrene, vinyl alcohol, N-vinyl pyrrolidone, vinyl acetate, vinyl chloride, vinyl ethers, vinyl sulfides, vinyl toluene, butadiene, isoprene, chloroprene, ethylene, isobutylene, vinylidene chloride, sulfated castor oil, sulfated sperm oil, sulfated soybean oil, and sulfonated dehydrated castor oil. Particularly useful monomers include, for example, alkyl acrylates having 1-4 carbon atoms, itaconic acid, sodium sulfostyrene, and sulfated castor oil. The mixtures of the monomers, such as, for example, sodium sulfostyrene and styrene, and sulfated castor oil and acrylic acid, can be copolymerized with the methacrylic acid.

The methacrylic polymers of the present disclosure relate to those prepared by polymerizing methacrylic acid, with or without at least one other ethylenically unsaturated monomer described above, in the presence of sulfonated hydroxy-aromatic compound/formaldehyde condensation resins. Those homopolymers and copolymers and their preparation are described in the U.S. Pat. No. 4,940,757 (Moss), the contents of which are incorporated herein by reference.

As mentioned above, an antimicrobial agent can be used in embodiments of the present disclosure. An “antimicrobial agent” can include a substance or combination of substances that kills or prevents or inhibits the growth of a microorganism. The agents include an antibiotic, an antifungal, an antiviral, and an antialgal agent. Suitable antimicrobials may also include fungicides. Examples include, but are not limited to, trialkyltin compounds such as tributyl tin oxide and tributyl tin acetate, copper compounds such as copper-8-quinilinolate, metal complexes of dehydroabietyl amine and 8-hydroxyquinium-2-ehtylhexoate, copper naphthenate, copper oleate, and organosilicon quaternary ammonium compounds.

Exemplary substrates for use in embodiments of the present disclosure include textile fabric, a thin layer of foam, or any thin layer of material suitable for use as part of a cushion such as batting.

Textile fabrics can be formed in any known manner, including weaving, knitting, braiding, nonwoven fabric manufacturing methods, thermobonding of fibers, or combination thereof. If a woven fabric is used, the fabric can be plain woven or can be woven to include a pattern. The fabric substrate can be of any weight desired for the particular end use application.

The substrate textile fabric can be formed of various types of fibers and/or yarns. The fiber materials include, but are not limited to, synthetic materials such as polyester, nylon, rayon, acetate, polypropylene and acrylics, and natural materials such as cotton, wool, linen, ramie, silk, flame-retardant fiber such as Nomex®, Visil® and Avora®, and the like, and the blends thereof.

A thin layer of foam useful as a substrate in embodiments of the present disclosure can be made from virgin polyurethane or re-bonded polyurethane. It can also be made from other types of foam suitable for use to make a cushion for seating.

A breathable polymeric film can be formed by any fabrication technique known in the art. For example, it can be extrusion coated, blown, or cast. The polymeric film may be made of any curable or crosslinkable resin, polymer, copolymer, blend, and the like, of polymeric material. Such polymeric materials include, but are not limited to, thermosetting and thermoplastic materials such as polyvinyl chloride, polyesters, polyamides, nylon, polysulfones, polyethylene, polypropylene, polychloroprene (neoprene), polystyrene, polymethylstyrene, polyethylene terephthalate, polyisoprene, polyvinyl acetate, polyvinylidene chloride, silicone resins, styrene-acrylonitrile copolymer resins, aliphatic and aromatic urethanes, and/or acrylates and their oligomers, polymethyacrylates, isobornyl acrylate, polymethylmethacrylates, diol diacrylates, styrene-butadiene copolymers, polycarbonates, polycaprolactams, natural rubber latex, and blends thereof.

In one embodiment, the material of the polymeric film includes a resilient perfluoroalkyl material or resilient elastomeric material such as butylene/poly(alkylene ether) phthalate copolymer material available from E. I. du Pont Nemours and Company, Wilmington, Del., under the trademark “HYTREL®”. Other resilient elastomeric materials include vulcanized silicone rubber, silicone polymer, polyurethanes, polyether/polyester, polyether/amides, polyvinyl alcohol, and copolymers and blends thereof.

In an embodiment, the film can be laminated on the fibrous substrate by methods well known to those skilled in the art in an amount sufficient to provide liquid-impermeability and a moisture vapor transport rate (MVTR) at least 100/g/m²/day. Such methods include the use of adhesives (adhesive lamination), heat bonds (thermal lamination), pressure bonding, dynamic mechanical bonding, and extrusion coating, or any other suitable attachment means, or combinations of these attachment means.

In an embodiment, the film can also be laminated using an ultrasonic welding technique. Typically, the layers to be laminated are fed through an ultrasonic treatment station where ultrasonic energy is applied. The station further includes a sonic horn that cooperates with a pinsonic roller to apply sonic energy to the laminates. By applying the sonic energy through the horn against the pinsonic roller, thermal energy is applied to the laminates and is concentrated at the pins on the pinsonic roller. Accordingly, the heat-fusible components of the laminates are fused at the points where the pins on the roller engage the fabric layers.

In an embodiment, a suitable adhesive can be used to laminate the polymeric film to the face side of the substrate. The adhesive may be one that is applied in a solid form, as in the form of solid powder, solid film or solid adhesive web. Particularly, a non-woven adhesive fibrous web can be used. If the adhesive used is a hot-melt adhesive, then the adhesive should have a melting temperature that is lower than the melting temperature of the material used to form the polymeric film such that the film is bond thermally to the face side of the fabric substrate.

In one embodiment of the present disclosure, a polymeric film can be adhered to the face side of a substrate by employing a thin suitable intermediate hot-melt adhesive layer between the polymeric film and the substrate. The intermediate hot-melt adhesive layer can be laminated between the substrate and the polymeric film by any known technique. The polymeric film can be supplied from a roll of performed polymeric film. A thin layer of hot-melt adhesive can be melted between the substrate and the polymeric film. The hot-melt adhesive can be applied in an amount of about 0.25 to 3 oz/yd² (9 to 100 g/m²) depending upon the adhesive, although less or more adhesive could be used, if desired. The adhesive, after being heated, can then be allowed to cool at room temperature to secure the polymeric film to the fabric.

In an embodiment, liquid adhesives can also be used. Suitable liquid adhesives for use are well known in the art. Examples include, but are not limited to, plastisol, epoxy, acrylic, organosol, and urethane adhesives. The liquid adhesives can be applied to the polymeric film by known coating techniques such as gravure cylinder, knife, roller, reverse roller, anilox roller, and laminated under heat between the film and the substrate.

The liquid impermeability of the cushion can be measured by using a hydrostatic testing machine and following an AATCC 127 test method. The vapor breathability of the cushion was tested by using an ASTM-E96 (Upright Cup Method).

In an embodiment of the present disclosure, a pad or a liner fabric can be coated directly with a polymeric composition to form a moisture permeable, and liquid-impervious layer. The suitable polymeric compositions include, but are not limited to, thermosetting and thermoplastic materials such as polyvinyl chloride, polyesters, polyamides, nylon, polysulfones, polyethylene, polypropylene, polychloroprene (neoprene), polystyrene, polymethylstyrene, polyethylene terephthalate, polyisoprene, polyvinyl acetate, polyvinylident chloride, silicone resins, styrene-acrylonitrile copolymer resins, aliphatic and aromatic urethanes, and/or acrylates and their oligomers, polymethylacrylates, isobornyl acrylate, polymethylmethacrylates, diol diacrylates, styrene-butadiene copolymers, polycarbonates, polycaprolactams, natural rubber latex, and blends thereof.

The following methods are exemplary methods for constructing cushions in accordance with the present disclosure. In the first method, the core of a pad is initially wrapped (or bagged) with the vapor-breathable liquid-impermeable laminate and then with the upholstery fabric. In the second method, the vapor-breathable liquid-impermeable laminate is pre-cut (or pre-sewn) together with the upholstery fabric, and then the upholstery and the laminate are combined together to wrap the core of a pad.

In an embodiment, the cushion can be made in any shape to fit upholstery furniture. For example, the cushion can be used as seat cushion, arm cushions, and a back cushion in making chairs and sofas. The cushion can also be used in making mattress.

Now having described embodiments of the present disclosure in general, the following examples describe some embodiments of the present disclosure and uses thereof. The following are non-limiting illustrative examples of an embodiment of the present disclosure that is not intended to limit the scope of any embodiment of the present disclosure, but rather is intended to provide some experimental conditions and results. Therefore, one skilled in the art would understand that many experimental conditions can be modified, but it is intended that these modifications be within the scope of the embodiments of the present disclosure.

### EXAMPLES

### Example 1

### Component Preparation

(a) Liquid-Impermeable Laminates

Different liquid-impermeable films were laminated with various substrates to form liquid-impermeable laminates, and the conditions for the lamination are listed in Table 1. The test results of vapor breathability (moisture vapor transferring rate, MVTR) of the laminates are also shown in Table 1.

TABLE 1
Preparation and Test Result of the Laminates

| | | | | | MVTR (upright |
|---|---|---|---|---|---|
| | | | | | cup method of |
| | Liquid- | | | Hydrostatic | ASTM E96) of |
| | impermeable | | Bonding | Reading | laminates, |
| # | Film | Substrate | conditions | (mbar) | g/m²/24 hrs |
| 1 | Adhesive- | Urethane foam | 180° C.; 0.5 psi; | >300 | 173 |
| | coated | sheet: ⅛″ | 20 sec | | |
| | copolyester film | thick; 1.8 oz/yd² | | | |
| | (15μ) (Hytrel ® | | | | |
| | film from | | | | |
| | DuPont, | | | | |
| | Wilmington, | | | | |
| | DE) | | | | |
| 2 | Polyurethane | Urethane foam | 160° C.; 0.5 psi; | >300 | 747 |
| | film (25μ) | sheet: ⅛″ thick | 20 sec | | |
| | (ET3801 from | 1.8 oz/yd² | | | |
| | Bemis | | | | |
| | Associates, | | | | |
| | Shirley, MA) | | | | |
| 3 | Adhesive- | PET spunlaced | 180° C.; 1.0 psi; | >300 | 173 |
| | coated | nonwoven: 2 oz/yd² | 20 sec | | |
| | copolyester film | (Style | | | |
| | (15μ) (Hytrel ® | 8005 from | | | |
| | film from | DuPont) | | | |
| | DuPont, | | | | |
| | Wilmington, | | | | |
| | DE) | | | | |
| 4 | Copolyester film | PET knit Tricot | 180° C.; 1.0 psi; 20 sec | >300 | 1302 |
| | (20μ) (Hytrel ® | liner fabric | | | |
| | film from | (Style 5233) | | | |
| | DuPont, | from Alexander | | | |
| | Wilmington, | Fabrics | | | |
| | DE) | | | | |
| 5 | Copolyester film | PET spunlaced | 180° C.; 1.0 psi; | >300 | 1243 |
| | (20μ) (Hytrel ® | nonwoven: 2 oz/yd² | 30 sec | | |
| | film from | (Style | | | |
| | DuPont, | 8005 from | | | |
| | Wilmington, | DuPont) | | | |
| | DE) | | | | |

(b) Upholstery Fabric

A commercial upholstery fabric of 100% polyester having a weight of 21.8 oz/yard² (739.3 g/m²) was treated with fluorochemical, Zonyl® 8070 (E. I. DuPont Co.), and cross-linking polycarbodiimide resin, Carbodilite E-02 (Advanced Polymer, Inc., Carlstadt, N.J.) in a padding bath and then dried in an oven.

### Example 2

### Detachable Seat Cushion A

Polyurethane foam was cut into a rectangular shape of 20″×20″×4″. The laminate #4 listed in Table 1 was cut into six pieces (two pieces of 20.5″×20.5″, and four pieces of 20.5″×4.5″). The six pieces were thread sewn together along the edges of the film sides (e.g., edge-sealing) except one edge of the last piece of 20″×4″ was left open. The film sides of the sewn laminate were then turned out to form a bag. The precut foam (20″×20″×4″) wrapped with a thin layer of batting was put inside of the bag through the opening. The opening was then sealed by sewing thread to form a laminate-wrapped pad. The laminate-wrapped pad was put inside of a pre-sewn upholstery bag and closed with a zipper to form an upholstery cushion. The measured vapor breathability (MVTR) of the upholstery cushion was 1202 g/m²/24 hrs. The softness and comfort of the cushion were the same as the cushion without the barrier layer.

### Example 3

### Detachable Seat Cushion B

Polyurethane foam was cut into a rectangular shape of 20″×20″×4″. An upholstery fabric sheet was combined with the laminate #4 so that the underside of the upholstery fabric was contacted with the film side of the laminate. The combination was then cut into six pieces (two pieces of 20.5″×20.5″, and four pieces of 20.5″×4.5″). The six pieces were thread-sewn together along the edges with the laminate facing out except one edge of the last piece of 20″×4″ was sewn with a 17″ long zipper. The upholstery side was turned out through the zipper opening to form a bag. The precut foam (20″×20″4″) wrapped with a thin layer of batting was put inside of the bag. The bag was then zipper closed to form a vapor-breathable liquid barrier seat cushion. The measured vapor breathability (MVTR) of upholstery cushion was 1202 g/m²/24hrs. The softness and comfort of the cushion were the same as the cushion without the barrier layer.

### Example 4

### Detachable Seat Cushion C

The cushion is the same as in Example 3 except Laminate #2 was used to make the cushion. The measured vapor breathability (MVTR) of the cushion was 685 g/m²/24 hrs. The softness and comfort of this cushion were the same as of the cushion without the barrier layer.

### Example 5

### Detachable Seat Cushion D

The construction of the cushion was the same as Example 4, except the laminate was changed into laminate #1, #3, or #5. The softness and comfort of the cushions were the same as those without the barrier layers.

### Example 6

### Detachable Seat Cushion E

The construction is the same as Example 2, except two layers of laminates were put on the four sides (20″×4″) of the cushion. For each side of the cushion, two horizontal cuts of 3 inches deep were made on the inner layer, and two vertical cuts of 3 inches deep were made on the outer layer that aligned with the horizontal cuts of the inner layer to form two crosses. The cuts allowed the air coming out from the inside of the cushion but prevented the liquid penetrating to the cushion.

### Example 7

### Seat Cushion Directly Anchored on Wood Frame

Polyurethane foam was cut into a piece of 20″×16″×1.5″ and the top of the foam was wrapped with batting (0.25″ thick). An upholstery fabric sheet was combined with laminate #4 with the underside of the upholstery fabric contacting the film side of the laminate. The combination was cut into 21″×17″. The combination and the wrapped foam were wrapped together onto a chair seat and directly anchored on the wood frame with decorated edge strips and decorated staples.

### Example 8

### Back Cushion

Polyurethane foam was cut into a piece of 20″×12″×1.5″ and the top of the foam was wrapped with batting (0.25″ thick). An upholstery fabric sheet was combined with laminate #4 with the underside of the upholstery fabric contacting the film side of the laminate. The combination was cut into 21″×13″. The combination and the wrapped foam were wrapped together onto a chair back and directly anchored on the wood frame with decorated edge strips and decorated staples.

### Example 9

### Mattress Cushion

A slap of twin-size urethane foam was cut into a piece of 78″×36″×9″ and was wrapped with batting (0.5″ thick) around the foam core. A ticking fabric sheet was combined with the laminate #4 with the underside of the ticking fabric contacting the film side of the laminate. The combination was cut into two pieces of 79″×37″ and two pieces of 115″×10″. The pieces were then thread-sewn together, leaving one of the long edges open. The ticking fabric was turned out from a bag, and pre-cut foam wrapped with batting was put inside of the bag. The open edge was thread-sewn.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also the individual concentrations (e.g., 1%, 2%, 3%, and 4%) and the sub-ranges (e.g., 0.5%, 1.1%, 2.2%, 3.3%, and 4.4%) within the indicated range. The term “about” can include ±10%, or more of the numerical value(s) being modified. In addition, the phrase “about ‘x’ to ‘y’” includes “about ‘x’ to about ‘y’”.

Many variations and modifications may be made to the above-described embodiments. All such modifications and variations are intended to be included herein within the scope of this disclosure and protected by the following claims.

What is claimed is:

1. A moisture-vapor-breathable and liquid-impermissible structure, comprising:
a substrate having an upper surface and a lower surface;
a moisture-vapor-breathable and liquid-impermissible laminate disposed over at least the upper surface of the substrate; and
an upholstery fabric sheet having a face side and an underside, wherein the underside of the upholstery fabric sheet is disposed over the moisture-vapor-breathable and liquid-impermissible laminate.

2. The structure according to claim 1, wherein upholstery fabric sheet is a treated fabric sheet, wherein the treated fabric sheet has been treated with a primary treatment composition.

3. The structure according to claim 2, wherein the primary treatment composition comprises a fluorochemical compound and a crosslinkable resin.

4. The structure according to claim 2, wherein the primary treatment composition further comprises a stain resistant agent.

5. The structure according to claim 2, wherein the primary treatment composition further comprises an antimicrobial agent.

6. The structure according to claim 1, wherein the moisture-vapor-breathable and liquid-impermissible laminate includes a polymeric barrier film having a face side and an underside, wherein the face side is disposed adjacent the underside of the upholstery fabric sheet and wherein the underside of the polymeric barrier film overlays the substrate.

7. The structure according to claim 1, wherein the moisture-vapor-breathable and liquid-impermissible laminate includes:
a) a polymeric barrier film having a face side and an underside, wherein the face side is disposed adjacent the underside of the upholstery fabric sheet; and
b) a polymeric adhesive layer covering the underside of the polymeric barrier film and wherein the polymeric adhesive layer overlays the substrate.

8. The structure according to claim 6, wherein the substrate is selected from the group consisting of: a foam, a fabric, a batting, and a combination thereof.

9. The structure according to claim 6, wherein the polymeric barrier film comprises a moisture-vapor-breathable and liquid-barrier film.

10. The structure according to claim 9, wherein the moisture-vapor-breathable and liquid-barrier film comprises a monolithic film.

11. The structure according to claim 10, wherein the monolithic film is selected from the group consisting of: a polyester-based thermoplastic elastomer film, a polyurethane-based thermoplastic elastomer film, a polyamide-based thermoplastic elastomer film, and a combination thereof.

12. The structure according to claim 9, wherein the moisture-vapor-breathable and liquid-barrier film is selected from the group consisting of: a microporous polypropylene film, a copolyester film, a microporous polytetrafluroethylene film, and a combination thereof.

13. The structure according to claim 6, wherein the upholstery fabric sheet is a treated fabric sheet, wherein the treated fabric sheet has been treated with a primary treatment composition.

14. The structure according to claim 1, wherein the substrate is a compressible resilient material.

15. The structure according to claim 1, wherein the substrate is selected from the group consisting of: a foam, a fabric, a batting, and a combination thereof.

16. An upholstery structure, comprising:
a structure having a moisture-vapor-breathable and liquid-impermissible property, wherein the structure includes:
a substrate having an upper surface and a lower surface;
a moisture-vapor-breathable and liquid-impermissible laminate disposed over at least the upper surface of the substrate; and
an upholstery fabric sheet having a face side and an underside, wherein the underside of the upholstery fabric sheet is disposed over the moisture-vapor-breathable and liquid-impermissible laminate.

17. The upholstery structure according to claim 16, wherein the upholstery fabric sheet is a treated fabric sheet, wherein the treated fabric sheet has been treated with a primary treatment composition that comprises a fluorochemical compound and a crosslinkable resin.

18. The upholstery structure according to claim 17, wherein the primary treatment composition further comprises an agent selected from the group consisting of: a stain resistant agent, an antimicrobial agent, and a combination thereof.

19. The upholstery structure according to claim 16, wherein the moisture-vapor-breathable and liquid-impermissible laminate comprises a moisture-vapor-breathable and liquid-impermissible laminate selected from the group consisting of:
a polymeric barrier film having a face side and an underside, wherein the face side is disposed adjacent the underside of the upholstery fabric sheet and the underside of the polymeric barrier film overlays the substrate; and
a polymeric barrier film having a face side and an underside, wherein the face side is disposed adjacent the underside of the upholstery fabric sheet, and a polymeric adhesive layer covering the underside of the polymeric barrier film and the polymeric adhesive layer overlays the substrate.

20. The upholstery structure according to claim 19, wherein the substrate is selected from the group consisting of: a foam, a fabric, a batting, and a combination thereof.

21. The upholstery structure according to claim 19, wherein the polymeric barrier film is selected from a polymeric barrier film selected from the group consisting of: a moisture-vapor-breathable and liquid-barrier film and a monolithic film, and a combination thereof.

22. The upholstery structure according to claim 21, wherein the monolithic film is selected from the group consisting of: a polyester-based thermoplastic elastomer film, a polyurethane-based thermoplastic elastomer film, a polyamide-based thermoplastic elastomer film, and a combination thereof.

23. The upholstery structure according to claim 16, wherein the structure is selected from the group consisting of: a pad, a cushion, and a padding.

24. The upholstery structure according to claim 16, wherein the upholstery structure is an upholstery furniture structure.

25. The upholstery structure according to claim 24, wherein the upholstery furniture structure is selected from: a bed, an ottoman, a chair, or a sofa.

26. A method for the preparation of a moisture-vapor-breathable and liquid-impermissible structure, comprising:
a) providing a substrate having an upper and lower surface;
b) disposing a moisture-vapor-breathable and liquid-impermissible laminate on at least the upper surface of the substrate; and
c) disposing an upholstery fabric sheet on the moisture-vapor-breathable and liquid-impermissible laminate.

27. The method according to claim 26, wherein disposing a moisture-vapor-breathable and liquid-impermissible laminate includes wrapping.

28. The method according to claim 27, wherein wrapping is selected from the group consisting of: edge-sealing, sewing, and a combination thereof.

29. The method according to claim 26, wherein disposing an upholstery fabric sheet includes wrapping.

30. The method according to claim 29, wherein wrapping is selected from the group consisting of: edge-sealing, sewing, and a combination thereof.

31. The method according to claim 26, wherein the substrate is selected from the group consisting of: a foam, a fabric, a batting, and a combination thereof.

32. The method according to claim 26, wherein the moisture-vapor-breathable and liquid-impermissible laminate comprises a moisture-vapor-breathable and liquid-impermissible laminate selected from the group consisting of:
a polymeric barrier film having a face side and an underside, wherein the face side is disposed adjacent the underside of the upholstery fabric sheet and the underside of the polymeric barrier film overlays the substrate; and
a polymeric barrier film having a face side and an underside, wherein the face side is disposed adjacent the underside of the upholstery fabric sheet, and a polymeric adhesive layer covering the underside of the polymeric barrier film and the polymeric adhesive layer overlays the substrate.

33. The method according to claim 26, wherein upholstery fabric sheet is a treated fabric sheet, wherein the treated fabric sheet has been treated with a primary treatment composition that comprises a fluorochemical compound and a crosslinkable resin.

34. The method according to claim 33, wherein the primary treatment composition further comprises an agent selected from the group consisting of: a stain resistant agent, an antimicrobial agent, and a combination thereof.

35. The structure according to claim 26, wherein the polymeric barrier film comprises a moisture-vapor-breathable and liquid-barrier film.

36. The structure according to claim 35, wherein the moisture-vapor-breathable and liquid-barrier film comprises a monolithic film.

37. The structure according to claim 36, wherein the monolithic film is selected from the group consisting of: a polyester-based thermoplastic elastomer film, a polyurethane-based thermoplastic elastomer film, a polyamide-based thermoplastic elastomer film, and a combination thereof.

38. The structure according to claim 35, wherein the moisture-vapor-breathable and liquid-barrier film is selected from the group consisting of: a microporous polypropylene film, a copolyester film, a microporous polytetrafluroethylene film, and a combination thereof.
